(19) United States
(12) Patent Application Publication
(10) Pub. No.: US 2016/0036996 A1
(43) Pub. Date: Feb. 4, 2016

(54) ELECTRONIC DEVICE WITH STATIC ELECTRIC FIELD SENSOR AND RELATED METHOD

(71) Applicant: Sony Corporation, Tokyo (JP)

(72) Inventors: Magnus Midholt, Lund (SE); Erik Westenius, Lund (SE); David de Leon, Lund (SE); Kare Agardh, Lund (SE); Ola Thorn, Limhamn (SE)

(21) Appl. No.: 14/467,588

(22) Filed: Aug. 25, 2014

Related U.S. Application Data
(60) Provisional application No. 62/032,552, filed on Aug. 2, 2014.

(51) Int. Cl. H04M 19/04; H04B 1/3827; G05B 11/01

(52) U.S. Cl. CPC H04M 19/04; G05B 11/01; H04B 1/3833

(57) ABSTRACT

Electronic devices and related methods employ a static electric field sensor to detect variations in the electric field around the electronic device. Detected changes in the electric field invoke the performance of associated functions, thereby achieving efficient user interaction with the electronic device and/or reducing power consumption by the electronic device.

### RELATED APPLICATION DATA

This application claims the benefit of U.S. Provisional Patent Application No. 62/032,552, filed Aug. 2, 2014, the disclosure of which is incorporated herein by reference in its entirety.

### TECHNICAL FIELD OF THE INVENTION

The technology of the present disclosure relates generally to electronic devices and, more particularly, to an electronic device with a static electric field sensor that generates an output signal that is used as a control signal for one or more functions of the electronic device.

### BACKGROUND

Electronic devices, such as mobile phones and tablet computers, have user inputs that are used in the control of the electronic device. Exemplary user inputs include buttons and a touch sensitive display. Motion sensors (e.g., accelerometers) also may be used to control the electronic device in response to certain movements. While these inputs generally perform very well, there remains room for improvement in the manner in which users interact with electronic devices and for reducing power consumption by electronic devices.

### SUMMARY

The disclosed electronic devices and related methods employ a static electric field sensor to detect variations in the electric field around the electronic device. Certain types of detected changes in the electric field invoke the performance of associated functions, thereby achieving efficient user interaction with the electronic device and/or reducing power consumption by the electronic device.

According to one aspect of the disclosure, a portable electronic device includes a motion sensor; an electric field sensor; and a control circuit, signals from the motion sensor indicative of motion of the electronic device and signals from the electric field sensor indicative of changes in static electric field surrounding the electronic device are input to the control circuit, the signals from the motion sensor and from the electric field sensor analyzed by the control circuit in combination with each other to control an operation of the electronic device.

According to one embodiment of the portable electronic device, the operation of the electronic device is control over a power consumption state of a component of the electronic device.

According to one embodiment of the portable electronic device, the control circuit wakes up the component of the electronic device from a power reduction state if both the signals from the motion sensor indicate motion exceeding a predetermined trigger level and the signals from the electric field sensor indicate a change in sensed electric field has occurred.

According to one embodiment of the portable electronic device, the motion sensor and the electric field sensor operate concurrently and, for the control circuit to wake up the component of the electronic device, the motion exceeding the predetermined trigger level and the change in sensed electric field must occur simultaneously or within a predetermined amount of time of each other.

According to one embodiment of the portable electronic device, operation of the electric field sensor and the motion sensor are carried out in series and the control circuit wakes up the motion sensor from a power reduction state if the change in sensed electric field is detected and subsequently wakes up the component of the electronic device if the motion exceeding the predetermined trigger level is detected within a predetermined amount of time of the motion sensor having been woken up.

According to one embodiment of the portable electronic device, the operation of the electronic device is fusion motion sensing of the electronic device in which the motion sensing is based on both the signals from the motion sensor and the signals from the electric field sensor.

According to another aspect of the disclosure, an electronic device that is stationary relative to movements of a person includes a power-consuming component; an electric field sensor; and a control circuit, signals from the electric field sensor indicative of changes in static electric field surrounding the electronic device are input to the control circuit, the signals from the electric field sensor analyzed by the control circuit to detect arrival of the person in an area near the electronic device and, triggered by the detection of the arrival of the person in the area near the electronic device, the control circuit wakes up the power-consuming component from a power reduction state.

According to one embodiment of the electronic device, the arrival of the person in the area near the electronic device is determined by sensing a change in electric field caused by electric field emissions of another electronic device carried by the person, the electric field emissions having recognizable characteristics to trigger the detection of the arrival of the person.

According to one embodiment of the electronic device, the recognizable characteristics are associated with a specific electronic device and distinguishable from other electronic devices.

According to one embodiment of the electronic device, the detection of the arrival of the person includes detecting changes in the electric field that are caused by characteristics of the person that are distinguishable from changes in the electric field that are caused by other persons.

According to another aspect of the disclosure, a portable electronic device includes a motion sensor; an electric field sensor; and a control circuit, signals from the motion sensor indicative of motion of the electronic device and signals from the electric field sensor indicative of changes in static electric field surrounding the electronic device are input to the control circuit; and wherein the control circuit is configured to determine that the electronic device has been placed on a surface in a stationary state based on the signals from the motion sensor and, while in the stationary state, the control circuit further configured to determine if a user of the electronic device moves away from the electronic device based on the signals from the electric field sensor and if the user moves away, change an operational mode of the electronic device.

According to one embodiment of the portable electronic device, the changed operational mode is an announcement mode for calls or messages received by the electronic device.

According to one embodiment of the portable electronic device, the change in announcement mode includes at least one of reducing or silencing a ringer of the electronic device or turning off display of visual message announcements.

According to one embodiment of the portable electronic device, the changed operational mode is a power savings mode of the electronic device.

According to one embodiment of the portable electronic device, the changed operational mode is a security mode and, before detection of the movement of the user away from the electronic device, the electronic device remains in an unlocked state.

According to one embodiment of the portable electronic device, the control circuit is further configured to monitor the signals from the electric field sensor to determine that the user has returned to the electronic device after having moved away from the electronic device, the control circuit restoring the operational state of the electronic device upon determining that the user has returned to the electronic device.

According to another aspect of the disclosure, a portable electronic device includes an electric field sensor that generates signals indicative of changes in static electric field surrounding the electronic device; a radio circuit over which communications for calls are carried out; and a control circuit configured to detect an incoming call and silence or reduce volume of a ringer used to announce the call when the signals from the electric field sensor indicate movement of a user's hand near the electronic device.

According to another aspect of the disclosure, a portable electronic device includes an electric field sensor that generates signals indicative of changes in static electric field surrounding the electronic device; a radio circuit over which communications for calls are carried out; a display with touch input functionality; and a control circuit configured to detect establishment of a call and deactivate the display and touch input functionality when the signals from the electric field sensor indicate movement of the electronic device toward a user's head.

According to one embodiment of the portable electronic device, the control circuit is further configured to reactivate the display and touch input functionality when the signals from the electric field sensor indicate movement of the electronic device away from the user's head.

### BRIEF DESCRIPTION OF THE DRAWINGS

FIG. 1 is a schematic block diagram of an electronic device in an exemplary environment with a user and an object.

FIG. 2 is a schematic block diagram of an electronic device in an exemplary environment where a user holds the electronic device.

FIGS. 3A and 3B area schematic block diagrams of systems for waking up an electronic device.

FIG. 3C is a schematic block diagram of a fusion motion sensing system.

FIG. 4 is a plot of changes in detected electric field strength over time.

FIG. 5 is a schematic block diagram showing exemplary components of an electronic device.

### DETAILED DESCRIPTION OF EMBODIMENTS

### 1. Introduction

Embodiments will now be described with reference to the drawings, wherein like reference numerals are used to refer to like elements throughout. It will be understood that the figures are not necessarily to scale. Features that are described and/or illustrated with respect to one embodiment may be used in the same way or in a similar way in one or more other embodiments and/or in combination with or instead of the features of the other embodiments.

Described below in conjunction with the appended figures are various embodiments of an electronic device and method of controlling the electronic device with variations in electric field. The electronic device is typically—but not necessarily—a portable electronic device, and may take any form factor including, but not limited to, a mobile telephone, a tablet computing device, a laptop computer, a gaming device, a camera (e.g., a point-and-shoot camera or an automated life-log camera), a media player or a wearable device such as smart glasses, a smart watch or a smart band (e.g., a wrist or headband with built-in electronics). The electronic device shown in the appended figures is a mobile telephone, but applicability of aspects of the invention is not limited to mobile telephones.

### 2. Overview

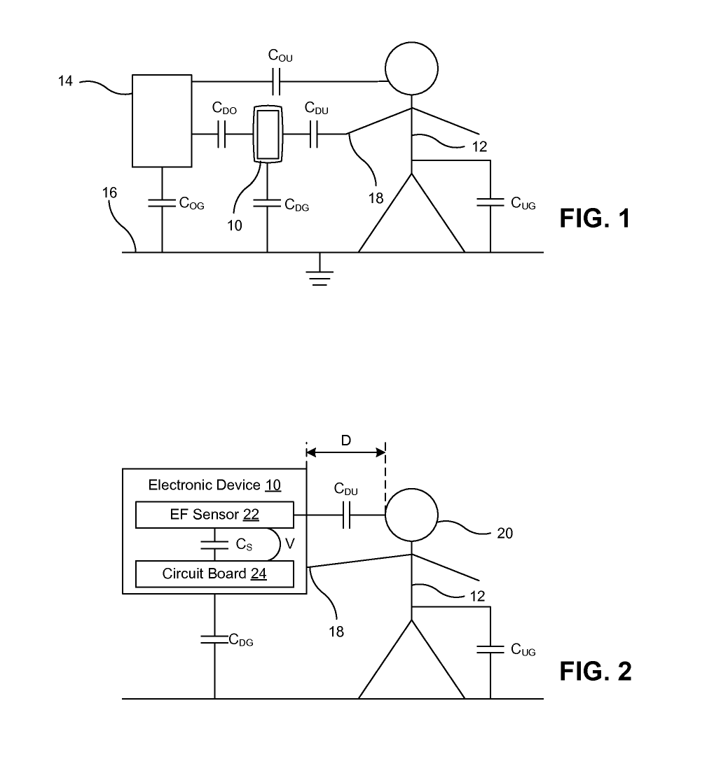

With initial reference to FIG. 1, illustrated is a schematic block diagram of an exemplary electronic device 10 in an operational environment. The illustrated, exemplary operational environment includes a user 12 of the electronic device 10 and another object 14. Various electrical and magnetic fields are present around the electronic device 10. These fields are generally generated by the flow of alternating current in cables, appliances, electronic devices, etc.

In addition to fields generated by alternating current, static electric fields are also present. The static field strength (or voltage potential) between two objects is dependent on the materials making up the objects, the relative position of the objects from one another, the distance between the objects, the relative movement between the objects, and any electrical connection or coupling to other objects in the environment.

To represent this electrical environment, a capacitance between each pair of items in FIG. 1 is schematically illustrated. Each item has a capacitance relative to a ground plane 16, indicated by C_{UG} for the capacitance between the user 12 and the ground plane 16, by C_{DG} for the capacitance between the electronic device 10 and the ground plane 16, and by C_{OG} for the capacitance between the object 14 and the ground plane 16. Also, each item has a capacitance relative to each other, indicated by C_{DU} for the capacitance between the electronic device 10 and the user 12, by C_{DO} for the capacitance between the electronic device 10 and the object 14, and by C_{OU} for the capacitance between the object 14 and the user 12.

Across each of these capacitances, a static electric field may be present. The electric field between any two of the objects in the environment may change. Thus, the total electric field as detectable at the electronic device 10 may change. These changes may be due to movement of the user 12 relative to the electronic device 10, movement of the object 14 relative to the electronic device 10, and movement of the user 12 relative to the object 14. The movements that cause changes in detectable electric field may be large-scale movements, such as the user 12 walking past the electronic device 10, or relatively small scale movements, such as the user 12 moving an arm in a reaching motion to pick up the electronic device 10. Changes in energy consumption by nearby electrical devices such as lights, appliances, and machines, also may result in changes in the electric field strength detectable by the electronic device 10.

Thus, it will be understood that materials and objects in an environment with electrical fields have voltage potentials towards other objects in the surrounding environment. More specifically, as soon as there is a voltage potential or current flowing near the electronic device 10, there will be an electrical field or fields generated in the location of the electronic device 10. But the detectable electric field strength is affected by varying voltage potentials between objects, and those potentials changes depending on factors such as user body size, user movement (e.g., walking, raising or lowering an arm, etc.) and other factors.

In FIG. 1, the user 12 is depicted as not touching the electronic device 10. With additional reference to FIG. 2, the user 12 is depicted as touching the electronic device 10 with the user's hand 18 (e.g., the user 12 is holding the electronic device 10 in the user's hand 18). But an electric field measurable by the electronic device 10 may still be affected by the distance D between a part of the user and the electronic device 10. In the illustrated example, the part of the user 12 is the user's head 20, although other parts of the user 12 (e.g., a leg or torso) may affect measurable electric field.

Continuing to refer to FIGS. 1 and 2, the electronic device 10 includes an electric field (EF) sensor 22. In one embodiment, the EF sensor 22 is capacitively coupled to a circuit board 24 to which other electrical components (described below) of the electronic device 10 are mounted. The capacitive coupling may be established with a capacitor or by separation of the EF sensor 22 and the circuit board 24 by an insulating medium. The capacitive coupling between the EF sensor 22 and the circuit board 24 is represented by Cₛ and a voltage potential between the EF sensor 22 and the circuit board 24 is represented by V.

A relatively simple way of implementing the EF sensor 22 and measuring electrical fields includes using a standard radio receiver used to receive broadcast transmissions (e.g., AM or FM transmissions). Another embodiment of implementing the EF sensor 22 and measuring electrical fields includes using an antenna and a sensing circuit. The power consumption of an EF sensing function implement in one of these manners is relatively low (e.g., as low as a couple of milliWatts).

An exemplary embodiment of the EF sensor 22 includes an EF antenna, a voltage meter (also referred to as a voltmeter) and a capacitor (e.g., capacitor Cₛ implemented with a physical circuit component). The capacitor has a first pole connected to the EF antenna and a second pole connected to a reference potential on the circuit board 24. The voltage meter measures the voltage across the capacitor and outputs an analog electrical signal indicative of variations in the electric field surrounding the electronic device 10. The analog signal from the voltmeter may be converted to a digital signal using an analog to digital (A/D) converter. The digital signal may be analyzed using digital signal processing and statistical analysis to identify and classify features and variations of the sensed electric field. Continuous or periodic scanning of the EF environment may be made with relative low power consumption (e.g., up to a few milliWatts). EF sensing may consume as little as 1.8 microAmps for sensing activity. Therefore, application of the EF sensor 22 may be made in wearable and portable electronic devices that typically operate using power from rechargeable batteries.

### 3. Motion Sensing

Conventional motion sensing in an electronic device has been carried out with MEMS-based systems, such as accelerometers and/or gyroscopes. Fusion sensing that employs MEMS-based systems can consume considerable amounts of power (e.g., about 600 microAmps) and are not always accurate, even for simple tasks such as counting footsteps in a pedometer mode. Fusion sensing is the use of multiple sensors and/or inputs together to detect user input or motion.

In ultra-low power mode, an accelerometer operating at about 1 Hz data rate may consume about 2 microAmps. In this mode, the accelerometer may trigger a response (e.g., wake-up the host electronic device or turn on a display) when motion exceeding predetermined thresholds along all three axes is detected. But general motion of the electronic device due to being carried about may trigger the response by the electronic device at unintended times.

In one embodiment, the EF sensor 22 and a motion sensor 26 (FIG. 5) are used in conjunction with one another to trigger a wake-up action, such as waking up the electronic device 10 from a sleep state, starting sensor fusion, turning on a display of the electronic device 10, or turning on some other function of the electronic device 10. Exemplary embodiments where the motion sensor 26 includes an accelerometer are described in this specification. Other types of motion sensors 26 are possible. For example, the motion sensor 26 may be implemented with one or more of an accelerometer, a gyro or gyros, a camera, optical sensor (e.g., an infrared (IR) sensor), or other sensor. It will be understood that the term “accelerometer,” as used herein, refers to a motion sensing assembly that includes at least one acceleration measuring component and possibly more than one acceleration measuring component, such as an acceleration measuring component for each of plural axes.

In one implementing embodiment, the motion sensor 26 is embodied as an accelerometer operating in ultra-low power mode. When both the accelerometer detects motion exceeding a predetermined trigger level and an output of the EF sensor 22 indicates a change in sensed EF has occurred, then an event indication signal may be generated. The change in sensed EF may be a specific type of change or a change that meets predetermined criteria, such as a rapid increase in EF or a rapid decrease in EF. In response to the event indication signal (also referred to as a wake-up signal), the electronic device 10 may undertake the appropriate wake-up action.

In this manner, the robustness of the wake-up function may be enhanced over only using an accelerometer. For example, if the desired wake up event is the user 12 grasping and picking up the electronic device 10, the accelerometer working in ultra-low power mode may detect threshold activity by movement other than being picked up in this manner. But threshold motion detection, in combination with a detection of a change in sensed EF, may reduce the instances of false-positive wake-up triggers.

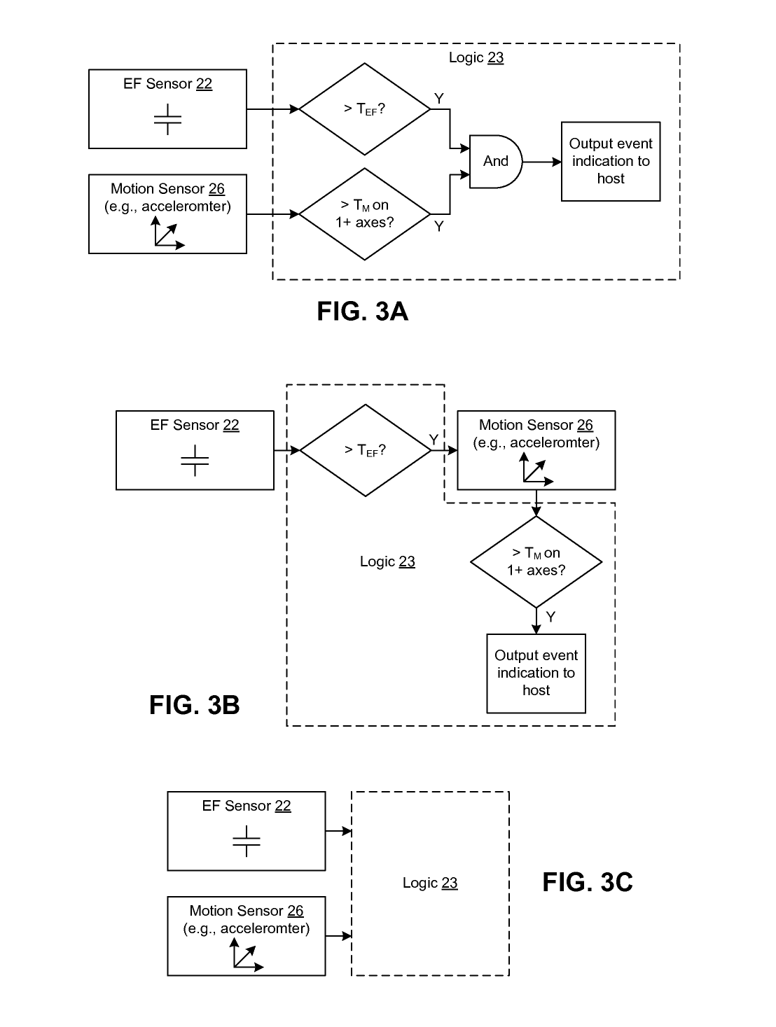

FIG. 3A illustrates one implementing embodiment of a system for waking up the electronic device 10. In this embodiment, the motion sensor 26 (e.g., accelerometer) and the EF sensor 22 operate concurrently. Output signals from the sensors 22 and 26 are input to a logic function 23, which may be implemented in hardware, software, or combination thereof as described below. In a typical embodiment, the logic function 23 is embodied as part of the electronic device 10. The event indication signal is generated and output to a host (e.g., a logical or physical component of the electronic device 10) if both the accelerometer and the EF sensor 22 output respective signals from which the logic function 23 makes triggering detections simultaneously or within a predetermined amount of time of each other. The triggering detection for the output of the EF sensor 22 may be a change in electric field exceeding a predetermined threshold, or T_{EF}. The triggering detection for the output from the accelerometer may be a change in motion exceeding a predetermined threshold, or T_{M}, along one axis, along each of two axes, or along each of three axes.

FIG. 3B illustrates another implementing embodiment of a system for waking up the electronic device 10. In this embodiment, the operation of the EF sensor 22 is placed in series with the operation of the motion sensor 26 (e.g., accelerometer) to further reduce power consumed in a sleep state. For instance, the accelerometer may be in an off state and the EF sensor 22 may be in a sensing state. If the logic function 23 determines that the output of the EF sensor 22 indicates that a change in sensed EF has occurred (e.g., T_{EF} is exceeded), the accelerometer may be activated. Then, if the logic function 23 determines that the accelerometer detects a change in motion within a predetermined amount of time of being activated and exceeding the predetermined threshold T_{M} along each of a predetermined number of axes (e.g., one axis, two axes, or all three axes), then the event indication signal may be generated and output to the host (e.g., a logical or physical component of the electronic device 10) to trigger the wake-up action of the electronic device 10.

The output of the EF sensor 22 may be used in conjunction with the output of the motion sensor 26 in manners other than for triggering a wake-up action. For example, as schematically shown in FIG. 3C, data collected from the EF sensor 22 and concurrently from the accelerometer may be feed into a fusion sensor algorithm of the logic function 23 for motion sensing. In many circumstances, this motion sensing arrangement may produce more reliable and/or accurate results than if the motion sensing was made just by using the output of the accelerometer. In one exemplary embodiment, the two outputs may be used for step counting in a pedometer function.

By collecting and using data from both the EF sensor 22 and the motion sensor 26 it is contemplated that the accuracy of certain motion sensing operations may be increased. For example, the most accurate pedometers on the market at the time of the writing of this disclosure use an accelerometer for motion detection and have accuracies within ±5 percent. But combining data from more than one sensor is considered to improve the accuracy of ongoing motion sensing. For instance, in the case of a pedometer that uses data from an accelerometer and from an EF sensor 22, it may be possible to increase the accuracy to within ±1 percent.

### 4. Stationary Device Wake-Up Function

In the foregoing section, operations to wake up functions of an electronic device 10 based on motion of the electronic device 10 were described. In other situations, the electronic device 10 may be stationary and the user 12 or another electronic device moves near the electronic device 10. In this case, electric field sensing is used to identify proximity of the user 12 (or other electronic device) and wakes up a function of the electronic device 10 based on the sensing of the person (or other electronic device). The wake-up action may be turning on a wireless interface to establish communication with an electronic device carried by the user 12. Other exemplary wake-up actions include waking up the electronic device 10 from a sleep state, starting sensor fusion, turning on a display of the electronic device 10, or turning on some other function of the electronic device 10. Upon detection of a person (or other electronic device) using EF sensing, it is possible that more than one wake-up actions are taken.

Many electronic devices enter a standby mode when not in use to save power. For instance, a wireless keyboard, mouse or speaker may enter a deep standby state when not in use. In the exemplary scenario where the electronic device 10 is a wireless speaker, the wireless speaker may receive an audio data signal from another electronic device over a Bluetooth or Wi-Fin interface. The received audio data is played out via a speaker so as to be heard by a user. In this exemplary situation, the source of the audio data may be a portable electronic device, such as a mobile phone or a tablet.

It is advantageous that, when a person wishes to use the electronic device 10 (e.g., listen to music in the case of a wireless speaker), the electronic device 10 is ready for use (e.g., to receive and play out audio data) without specific user interaction. Therefore, there is a need for the electronic device 10 to have a very low power-consumption standby mode while also being able to readily wake up and perform its functions when desired by a user.

To accomplish these operations, the electronic device 10 performs EF sensing in the sleep state to detect changes in the surrounding environment. Using EF sensing, it is possible to detect EF changes indicative of a person entering or leaving a room, EF changes indicative of a light being turned on or off, and so forth. These types of events are typically characterized by predictable EF changes and, therefore, may be distinguished from other EF changes. When the electronic device 10 detects EF changes corresponding to a predetermined type of activity (e.g., a person entering a room), the electronic device 10 turns on and enables one or more appropriate functions. In the exemplary embodiment where the electronic device 10 is a wireless speaker, the functions may be turning on its wireless interface and playing music received from another electronic device (e.g., the mobile phone of a user).

In one embodiment, the electronic device 10 is configured to identify specific objects that come into proximity with the electronic device 10. The specific objects may be a specific individual or a specific electronic device. The detection of the presence of a specific person or electronic device may be carried out by recognizing EF characteristics that are predetermined to correspond with the specific person or electronic device. EF characteristics that may have recognizable features include, but are not limited to, an EF signal patterns, EF spectrum, and variations in EF energy. The electronic device 10 may be configured to perform the wake-up functions when predetermined EF characteristics are recognized. In this way, predetermined users or predetermined electronic devices may cause the electronic device 10 to wake-up, but other persons and electronic devices will not cause the electronic device 10 to wake-up. In one exemplary embodiment, a portable electronic device is configured to emit an EF signal and the electronic device 10 wakes up on recognition of the EF signal emitted by the electronic device. The emitted EF signal need not be very intense. Rather, the signal may induce change in the existing, detectable EF around the electronic device 10. In another exemplary embodiment, the electronic device 10 may be configured to wake up in response to changes in electric field caused when an adult enters the room containing the electronic device 10 but not when a child or pet (e.g., a dog or a cat) enters the room.

### 5. Control of Mobile Device Functions

Portable electronic devices, such as mobile phones, have a variety of communication functions and other operational functions. In this section of the disclosure, control over various functions based on sensed electric field will be described.

### 5(A). User Presence to Control Electronic Device States

In typical use, the electronic device 10, when configured as a mobile phone or other portable electronic device, is physically handled in a number of ways by the user 12. Some of the time, the electronic device 10 is held or carried in the user's hand 18. At other times, the electronic device may be placed on a surface, such as a table or countertop, or placed on a charging stand. At other times, the electronic device 10 may be placed in a bag (e.g., purse, backpack or briefcase) or in a pocket.

Distinguishing when the electronic device 10 is in motion or is held in a user's hand from when the electronic device 10 is placed on a surface may be made using the motion sensor 26 (e.g., accelerometer output). But in conventional electronic devices 10, it is difficult to determine the proximity of the user 12. For instance, when the electronic device 10 has been placed on a level surface (e.g., a table top), the conventional electronic device is incapable of determining if the user is nearby (e.g., within arm's reach of the electronic device) or if the user has moved away (e.g., out of arm's reach, out of visual sight of the electronic device or in another room). Depending on the distance with which the user has moved away, it is possible that ringing of the electronic device 10 to announce an incoming call will be ineffective to alert the user to an incoming call and/or could be disturbing to others. Similarly, on-screen notifications (e.g., text messages or reminders) could be read by others and may be missed by the user 12. Therefore, knowledge of the user's proximity to the electronic device 10 when left on a stationary surface may be useful information that could be used to adapt operational behavior of the electronic device 10 to reduce disturbance to others, reduce missing important notifications, improve security, decrease power consumption, etc.

In one embodiment, the electronic device 10 detects when the electronic device 10 is placed on a stationary surface, such as the level surface of a table top. Determination of placement on a stationary surface may be made by monitoring the output of the motion sensor 26. When a determination that the electronic device 10 has been placed on a stationary surface is made, the electric field at the electronic device 10 is sampled with the EF sensor 22. A delay between placement on a stationary surface and EF sensing of about a half second to about a second may be employed to allow the user to release the electronic device 10. The sampled electric field serves as a baseline reading of the electric field when the user is proximal to the electronic device 10 (e.g., within arm's reach of the electronic device 10) under the assumption that the user has just placed the electronic device 10 on the surface and is nearby the electronic device 10 having just let go of the electronic device 10.

Next, movement of the electronic device 10 is monitored, such as by using the above-mentioned ultra-low power motion sensing operation. As long as the electronic device 10 remains stationary, the electric field is sampled (e.g., periodically every few seconds or continuously). If a gross-scale change in electric field is detected (e.g., a change exceeding a predetermined threshold), the electronic device 10 will interpret the change in electric field as the user 12 moving away from the electronic device. In one embodiment, the detection of gross-scale changes in electric field is calibrated to reduce changes from the movement of other persons or the turning on or off of electrical devices from being interpreted as the movement of the user moving away from the electronic device 10. For instance, it is contemplated that body movement will result in slower changes in electric field compared to changes in electric field caused by changes in the operational state of electrical devices. Also, the pattern of a change in electric field caused by the user moving away from the electronic device 10 will typically be different than the changes in electric field caused by movement of other persons since, in the described situation, other persons are typically further away from the electronic device 10 than the user 12 following placement of the electronic device 10 on the surface. In addition, a learning algorithm may be employed to create classifiers for sensed changes in electric field to improve results of the interpretation of changes in sensed electric field. For example, the changes in sensed electric field caused by movements of the user 12 may be different than changes in sensed electric field caused by the movements of others due to differences in body size, shape and/or mannerisms.

Following a determination that the user has left the area of the electronic device 10 as detected by variations in the sensed electric field, operational functions of the electronic device 10 may be modified. For instance, the electronic device 10 may change from a first announcement mode to a second announcement mode to change in the manner in incoming calls, messages and alerts are announced to the user. After a detection that the user has left the area of the electronic device 10, the sensing of the electric field may continue on a continuous or period basis to determine if the user 12 has returned to the area of the electronic device 10. If a determination is made that the user 12 has returned, then the electronic device 10 may transition from the second announcement mode back to the first announcement mode. Alternatively, for enhanced security, the electronic device 10 may remain in the second announcement mode until being unlocked by user action. In one embodiment, the electronic device 10 may wait for a short interval (e.g., between about 20 seconds and about one minute) before switching announcement modes to allow the user to establish distance from the electronic device 10. If the user returns before the interval elapses, the announcement modes need not be switched on the basis that the user did not travel far from the electronic device 10 and return within a short period of time. In one embodiment, the electronic device 10 may provide visual feedback on the display or auditory feedback when changing announcement modes. Exemplary audio feedback when switching from the first announcement mode to the second announcement mode is a distinctive locking sound, such as the sound a car makes when locked remotely with a wireless key fob.

In the first announcement mode, the electronic device 10 may announce an incoming call based on ringtone and vibration settings established by the user 12. For example, a call may be announced by outputting an audible ringtone and/or vibrating. Also, in the first announcement mode, the electronic device 10 may announce an incoming text message or email message in accordance with default or user settings, which typically include a visual display of at least part of the message, output an audible sound and/or by vibration. Similarly, calendar alerts and other events may be announced in accordance with default or user settings (e.g., with a visual display and/or with an audible sound).

The second announcement mode may be a silent mode where no audible output or vibration is made in response to incoming calls, incoming messages or other events. Also, visual display associated with incoming calls, incoming messages and other events may be turned off. These changes may have the effect of conserving power, increasing security, and reducing disturbance to others, such as co-workers in a workplace environment. In one embodiment, when the user returns to the electronic device 10, the notifications associated with messages received and events occurring during the time the user was away from the electronic device 10 may be displayed. If displayed notifications are not turned off in the second announcement mode, the notifications that were displayed while the user was away from the electronic device 10 may be re-displayed when the user returns.

In another embodiment, the second announcement mode may turn on and/or increase the volume of audio output to announce incoming calls, messages or other events. This may be useful to enable the user hear a ringtone or other audio alert when away from the electronic device 10. These changes may be appropriate in a home environment or a loud workplace.

The nature of the changes between the first and second announcement modes (e.g., going to a silent or secure mode or going to a louder mode) may be set by user selection. In one embodiment, the user may select among plural announcement modes according to location or other criteria. In this embodiment, the electronic device 10 may switch to an appropriate announcement mode using additional input data when the user leaves the area of the electronic device 10. For instance, announcement modes may be based on location geo-fencing. Alternatively, Wi-Fi network identity may be used to assist in transitioning to an appropriate announcement mode.

Other modes of the electronic device 10 may change in addition to or instead of the announcement mode. For example, a security mode may change when electric field monitoring indicates that the user has left the area of the electronic device 10. In one embodiment, as long as the user 12 is near the electronic device 10 an unlocking of the electronic device 10 may not require a passcode or other verification or may require a simple unlock action. But, if the user 12 has left the area of the electronic device, a subsequent unlocking action may require satisfaction of a security routine (e.g., entry of a code or biometric scan). This approach means that the user 12 can keep the electronic device 10 nearby on a table or other surface in an unlocked state and use the electronic device 10 intermittently without satisfying a security routine. But the user's departure from the area of the electronic device 10 will result in a secure locking of the electronic device 10.

Another exemplary mode that may be changed is a power savings mode. For instance, while the user is away from the electronic device 10, the electronic device 10 may be placed in a low power consumption mode (e.g., a sleep state or other power saving mode). In one embodiment, a cellular radio, a Wi-Fi radio, a Bluetooth radio or other wireless interface of the electronic device 10 may be turned off while the user is away from the electronic device 10. Other components and/or features also may be turned off, such as a display.

### 5(B). Hand Movement Detection to Control Ringtone for Incoming Call Handling

The ringing of a mobile phone at inopportune times (e.g., during a meal or during a meeting) or in inappropriate locations (e.g., a theater, museum, etc.) can be embarrassing or problematic for the user. In these situations, as well as other situations, the user may want to quickly silence the ringing or at least lower the ring volume. The conventional approach to ring silencing is for the user to physically interact with the mobile phone by pressing a button or touch control on a display. But this approach takes time, involves determining the exact location of the electronic device if it is in a pocket or in a bag, and relies on accurate physical interaction with the appropriate component of the electronic device.

In one embodiment, hand motion as detected by the EF sensor 22 is used to silence or reduce ringer volume of the electronic device 10 when a ringtone is played to announce an incoming call. In one embodiment, the hand motion used to control ringer volume is a movement of the user's hand 18 toward the electronic device 10.

In an exemplary implementation, the electronic device 10 may monitor a location state of the electronic device 10. Exemplary location states include, but are not limited to, handheld, in a pocket, in a bag or on a stationary surface. Determination of the current location state is described in other patent applications by the applicant and will not be described in detail. Briefly, location state may be determined using one or more inputs from sensors such as an accelerometer or a camera, and may involves vibration analysis in the form of user tremor detection. Periodically, a baseline scan of the electric field as detected by the EF sensor 22 may be made for use in comparison to scans made during an incoming call.

Next, when an incoming call is detected and at least one of the ringer and/or the vibrator is turned on to announce the call, a scan of the electric field with the EF sensor 22 is made. In one embodiment, several discrete scans may be made or continuous scanning during the incoming call announcement period may be made. In one embodiment, no scanning and no change to incoming call announcement is made if the electronic device 10 is in certain location states. For instance, if the electronic device 10 is already in a user's hand, there is little need to detect a reaching motion toward the electronic device 10. In one embodiment, to remove possible errors in the interpretation of changes in the sensed electric field, no scanning or change to incoming call announcement is made if the electronic device 10 is in a bag or in a pocket. On the other hand, these may be situations where silencing or reduction in the ringtone volume is desirable and scanning to change incoming call announcement is made in these situations.

If the electronic device 10 detects a change in electric field indicative of hand movement above or near the electronic device 10, then the ringer volume may be reduced or the ringer may be silenced. If calls are additionally or alternatively announced using a vibrator, then the intensity of the vibrator may be reduced or the vibrator may be turned off if hand movement above or near the electronic device 10 is detected.

In one embodiment, measured changes in electric field may be mapped into a volume control function to control incoming call announcement. For example, electric field variations indicating a hand wave over or near the electronic device 10 may silence the ringer and electric field variations indicating movement toward and grasping the electronic device 10 may reduce or silence ringer volume and start a call answer operation. In another embodiment, the speed of movement of the hand 18 toward the electronic device 10 may be determined. If the speed is over a predetermined threshold, then the ringer may be silenced. If the movement speed is below the threshold, then the ringer volume may be gradually reduced as the hand 18 moves closed to the electronic device 10, possibly at a rate coordinated with the rate of hand movement.

In one embodiment, the output signal of the EF sensor 22 is filtered and/or smoothed. These operations may be used to remove spikes in the output signal of the EF sensor 22. In addition, a sampling rate may be set to an appropriate sampling rate. For instance, it has been found that typical hand motion when reaching for or moving an electronic device 10 is about 400 millimeters per second (mm/s). At this speed, 16 events may be sampled over a range of movement of 10 centimeters using a sampling rate of 150 Hz. Under these conditions, hand movement may be detected and coordinated changes in ringer volume may be made.

In addition, the detection range of the EF sensor 22 may be controlled. Detection range is dependent on the hardware used to implement the EF sensor 22 (which is typically invariant) and gain of the EF sensor 22, which may be adjustable depending on the sensing operation. For ringer control, an exemplary detection range is about 5 cm to about 30 cm. It is contemplated that using this range will lower interference from EF changes in the surrounding environment. Additionally, shielding may be placed around the EF sensor 22 to establish a detection direction of the EF sensor 22.

### 5(C). Display Control During Calls

During a telephone call, a user of a mobile phone may hold the mobile phone to the user's ear. In cases where the mobile phone has a touch screen, it is very likely that the touch screen will touch the user's skin. Touching of the touch screen will activate the display and touch screen functions, which will consume power and may result in the inadvertent activation of one or more functions. Therefore, to minimize activation of the display and touch screen functions during a call where the user holds the mobile phone to the user's ear, a proximity sensor is used to determine if the display is held close to the skin. A typical proximity sensor includes an infrared (IR) light emitting diode (LED) and coordinating photoreceptor. This type of proximity sensor consumes around a half milliAmp, which is a high level of power consumption to place another component (the display and touch screen) in a stand-by stand.

In one embodiment, output of the EF sensor 22 is used to control an activation (e.g., standby or on/off) state of a display 28 (FIG. 5) and touch screen input 30 (FIG. 5) during a call. In one approach, the electronic device 10 detects an incoming call and an action to answer the call (e.g., a touch screen swipe or other action) or detects the initiation of an outgoing call by the user. It may be assumed by the electronic device 10 that the electronic device 10 is held in the user's hand 18 at this point as schematically illustrated in FIG. 2.

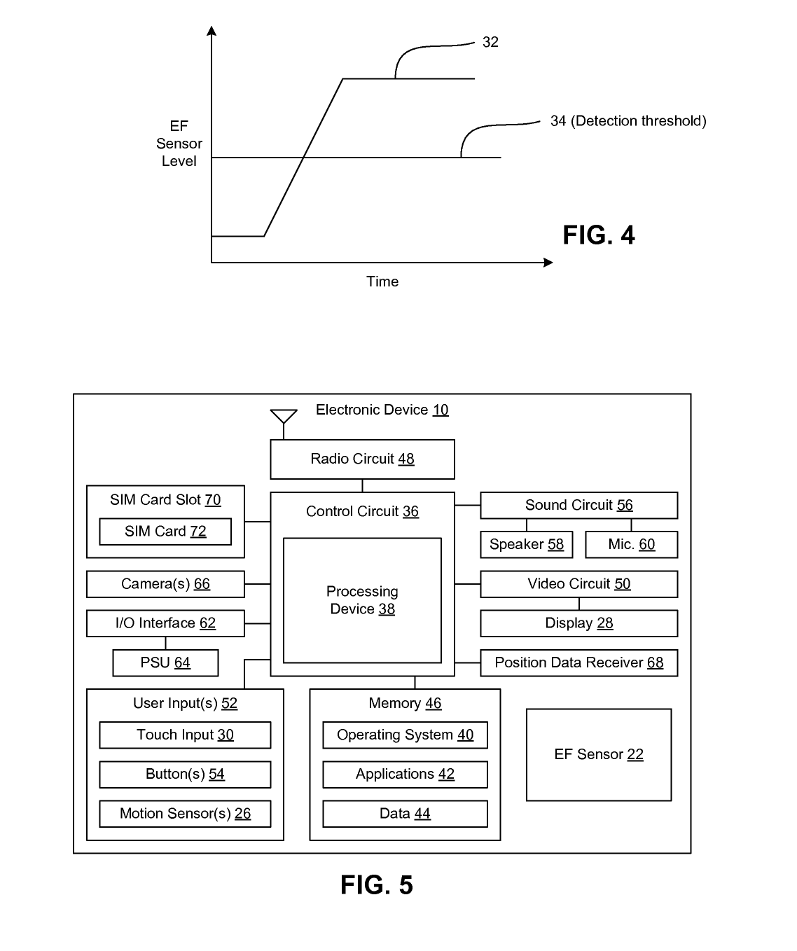

Next, the electronic device 10 monitors the output of the EF sensor 22 to detect a change in electric field indicative of movement of the electronic device 10 toward the user's head 20 so that distance D is decreasing. With additional reference to FIG. 4, when the signal from the EF sensor 22 (represented by curve 32) crosses (e.g., rises above) a predetermined detection threshold 34 or when other signal processing of the output of the EF sensor 22 indicates that the distance between the electronic device 10 and the user's head 18 becomes less than a predetermined distance threshold, then the display 28 and touch screen input 30 may be placed in an inactive state to reduce power consumption and protect against inadvertent activation of operations via interaction with the touch screen input 30. When the display 28 is inactivate, at least a backlight of the display 28 turned off.

In one embodiment, the predetermined detection threshold 34 is established to avoid deactivation of the display 28 and the touch screen input 30 by touching of the electronic device 10 with the user's hand 18 if the electronic device 10 has yet to be grasped or picked up in the time between an incoming call is detected and movement to the head 18 is detected. In one embodiment, the output of the EF sensor 22 may be used in combination with output of the motion sensor 26 (e.g., accelerometer) to make the determination of when to deactivate of the display 28 and the touch screen input 30.

During the call, monitoring of the output of the EF sensor 22 may continue to determine if the user moves the electronic device 10 away from the user's head 18. If this movement is detected, the display 28 and touch screen input 30 may be reactivated. Detection of movement of the electronic device 10 away from the user's head 18 may be made by determining that the signal from the EF sensor 22 crosses (e.g., drops below) a predetermined detection threshold 34 or when other signal processing of the output of the EF sensor 22 indicates that the distance between the electronic device 10 and the user's head 18 becomes greater than a predetermined distance threshold.

In one embodiment, the output signal of the EF sensor 22 is filtered and/or smoothed. In addition, a sampling rate may be set to an appropriate sampling rate. These operations may be used to remove spikes in the output signal of the EF sensor 22 and reduce hysteresis. For instance, it has been found that typical hand motion when moving an electronic device 10 toward and away from the head is about 400 millimeters per second (mm/s). At this speed, 4 events may be sampled over a range of movement of 4 centimeters using a sampling rate of 40 Hz. Under these conditions, hand movement may be detected and coordinated changes in activation state of the display 28 and touch screen input 30 may be made.

In addition, the detection range of the EF sensor 22 may be controlled. Detection range is dependent on the hardware used to implement the EF sensor 22 (which is typically invariant) and gain of the EF sensor 22, which may be adjustable depending on the sensing operation. For the embodiment described in this section, an exemplary detection range is about 4-5 cm. It is contemplated that using this range will lower interference from EF changes in the surrounding environment. Additionally, shielding may be placed around the EF sensor 22 to establish a detection direction of the EF sensor 22, such as forward-facing relative to the display 28.

### 6. Exemplary Electronic Device

As indicated, an exemplary configuration for the electronic device 10 is a mobile telephone. Although the electronic device 10 may be configured as other devices (e.g., a wireless speaker, a wireless mouse or keyboard, a tablet, etc.), the exemplary configuration as a mobile telephone will be described in greater detail.

With reference to FIG. 5, illustrated is a schematic block diagram of the electronic device 10 in its exemplary form as a mobile telephone. The electronic device 10 includes a control circuit 36 that is responsible for overall operation of the electronic device 10, including controlling the electronic device 10 in response to detections made by the EF sensor 22. The control circuit 36 includes a processor 38 that executes an operating system 40 and various applications 42. Typically, control functions that involve electric field sensing are embodied as part of the operating system 40. In other embodiments, this functionality may be embodied as a dedicated application or part of an application used for other tasks.

The operating system 40, the applications 42, and stored data 44 (e.g., data associated with the operating system 40, the applications 42, and user files), are stored on a memory 46. The operating system 40 and applications 42 are embodied in the form of executable logic routines (e.g., lines of code, software programs, etc.) that are stored on a non-transitory computer readable medium (e.g., the memory 46) of the electronic device 10 and are executed by the control circuit 36. The functions described in the preceding sections may be thought of as methods that are carried out by the electronic device 10.

The processor 38 of the control circuit 36 may be a central processing unit (CPU), microcontroller, or microprocessor. The processor 38 executes code stored in a memory (not shown) within the control circuit 36 and/or in a separate memory, such as the memory 46, in order to carry out operation of the electronic device 10. The memory 46 may be, for example, one or more of a buffer, a flash memory, a hard drive, a removable media, a volatile memory, a non-volatile memory, a random access memory (RAM), or other suitable device. In a typical arrangement, the memory 46 includes a non-volatile memory for long term data storage and a volatile memory that functions as system memory for the control circuit 36. The memory 46 may exchange data with the control circuit 36 over a data bus. Accompanying control lines and an address bus between the memory 46 and the control circuit 36 also may be present. The memory 46 is considered a non-transitory computer readable medium.

The electronic device 10 includes communications circuitry that enables the electronic device 10 to establish various wireless communication connections. In the exemplary embodiment, the communications circuitry includes a radio circuit 48. The radio circuit 48 includes one or more radio frequency transceivers and an antenna assembly (or assemblies). In the case that the electronic device 10 is a multi-mode device capable of communicating using more than one standard and/or over more than one radio frequency band, the radio circuit 48 represents one or more than one radio transceiver, one or more than one antenna, tuners, impedance matching circuits, and any other components needed for the various supported frequency bands and radio access technologies. Exemplary network access technologies supported by the radio circuit 48 include cellular circuit-switched network technologies and packet-switched network technologies (e.g., WiFi). The radio circuit 48 further represents any radio transceivers and antennas used for local wireless communications directly with another electronic device, such as over a Bluetooth interface.

The electronic device 10 further includes the display 28 for displaying information to a user. The display 28 may be coupled to the control circuit 36 by a video circuit 50 that converts video data to a video signal used to drive the display 28. The video circuit 50 may include any appropriate buffers, decoders, video data processors and so forth.

The electronic device 10 may include one or more user inputs 52 for receiving user input for controlling operation of the electronic device 10. Exemplary user inputs 52 include, but are not limited to, the touch sensitive input 30 that overlays or is part of the display 28 for touch screen functionality, one or more buttons 54, motion sensors 26 (e.g., the above-mentioned gyro sensor(s), accelerometer(s), camera(s), IR sensor(s), etc.), and so forth.

The electronic device 10 may further include a sound circuit 56 for processing audio signals. Coupled to the sound circuit 56 are a speaker 58 and a microphone 60 that enable audio operations that are carried out with the electronic device 10 (e.g., conduct telephone calls, output sound, capture audio for videos, etc.). The sound circuit 56 may include any appropriate buffers, encoders, decoders, amplifiers and so forth.

The electronic device 10 may further include one or more input/output (I/O) interface(s) 62. The I/O interface(s) 62 may be in the form of typical electronic device I/O interfaces and may include one or more electrical connectors for operatively connecting the electronic device 10 to another device (e.g., a computer) or an accessory (e.g., a personal handsfree (PHF) device) via a cable. Further, operating power may be received over the I/O interface(s) 62 and power to charge a battery of a power supply unit (PSU) 64 within the electronic device 10 may be received over the I/O interface(s) 62. The PSU 64 may supply power to operate the electronic device 10 in the absence of an external power source.

The electronic device 10 also may include various other components. As an example, one or more cameras 66 may be present for taking photographs or video, or for use in video telephony. As another example, a position data receiver 68, such as a global positioning system (GPS) receiver, may be present to assist in determining the location of the electronic device 10. The electronic device 10 also may include a subscriber identity module (SIM) card slot 70 in which a SIM card 72 is received. The slot 70 includes any appropriate connectors and interface hardware to establish an operative connection between the electronic device 10 and the SIM card 72.

### 7. Conclusion

Although certain embodiments have been shown and described, it is understood that equivalents and modifications falling within the scope of the appended claims will occur to others who are skilled in the art upon the reading and understanding of this specification.

What is claimed is:

1. A portable electronic device, comprising:
a motion sensor;
an electric field sensor; and
a control circuit, signals from the motion sensor indicative of motion of the electronic device and signals from the electric field sensor indicative of changes in static electric field surrounding the electronic device are input to the control circuit, the signals from the motion sensor and from the electric field sensor analyzed by the control circuit in combination with each other to control an operation of the electronic device.

2. The portable electronic device of claim 1, wherein the operation of the electronic device is control over a power consumption state of a component of the electronic device.

3. The portable electronic device of claim 2, wherein the control circuit wakes up the component of the electronic device from a power reduction state if both the signals from the motion sensor indicate motion exceeding a predetermined trigger level and the signals from the electric field sensor indicate a change in sensed electric field has occurred.

4. The portable electronic device of claim 3, wherein the motion sensor and the electric field sensor operate concurrently and, for the control circuit to wake up the component of the electronic device, the motion exceeding the predetermined trigger level and the change in sensed electric field must occur simultaneously or within a predetermined amount of time of each other.

5. The portable electronic device of claim 3, wherein operation of the electric field sensor and the motion sensor are carried out in series and the control circuit wakes up the motion sensor from a power reduction state if the change in sensed electric field is detected and subsequently wakes up the component of the electronic device if the motion exceeding the predetermined trigger level is detected within a predetermined amount of time of the motion sensor having been woken up.

6. The portable electronic device of claim 1, wherein the operation of the electronic device is fusion motion sensing of the electronic device in which the motion sensing is based on both the signals from the motion sensor and the signals from the electric field sensor.

7. An electronic device that is stationary relative to movements of a person, comprising:
a power-consuming component;
an electric field sensor; and
a control circuit, signals from the electric field sensor indicative of changes in static electric field surrounding the electronic device are input to the control circuit, the signals from the electric field sensor analyzed by the control circuit to detect arrival of the person in an area near the electronic device and, triggered by the detection of the arrival of the person in the area near the electronic device, the control circuit wakes up the power-consuming component from a power reduction state.

8. The electronic device of claim 7, wherein the arrival of the person in the area near the electronic device is determined by sensing a change in electric field caused by electric field emissions of another electronic device carried by the person, the electric field emissions having recognizable characteristics to trigger the detection of the arrival of the person.

9. The electronic device of claim 8, wherein the recognizable characteristics are associated with a specific electronic device and distinguishable from other electronic devices.

10. The electronic device of claim 7, wherein the detection of the arrival of the person includes detecting changes in the electric field that are caused by characteristics of the person that are distinguishable from changes in the electric field that are caused by other persons.

11. A portable electronic device, comprising:
a motion sensor;
an electric field sensor; and
a control circuit, signals from the motion sensor indicative of motion of the electronic device and signals from the electric field sensor indicative of changes in static electric field surrounding the electronic device are input to the control circuit; and
wherein the control circuit is configured to determine that the electronic device has been placed on a surface in a stationary state based on the signals from the motion sensor and, while in the stationary state, the control circuit further configured to determine if a user of the electronic device moves away from the electronic device based on the signals from the electric field sensor and if the user moves away, change an operational mode of the electronic device.

12. The portable electronic device according to claim 11, wherein the changed operational mode is an announcement mode for calls or messages received by the electronic device.

13. The portable electronic device according to claim 12, wherein the change in announcement mode includes at least one of reducing or silencing a ringer of the electronic device or turning off display of visual message announcements.

14. The portable electronic device according to claim 11, wherein the changed operational mode is a power savings mode of the electronic device.

15. The portable electronic device according to claim 11, wherein the changed operational mode is a security mode and, before detection of the movement of the user away from the electronic device, the electronic device remains in an unlocked state.

16. The portable electronic device according to claim 11, wherein the control circuit is further configured to monitor the signals from the electric field sensor to determine that the user has returned to the electronic device after having moved away from the electronic device, the control circuit restoring the operational state of the electronic device upon determining that the user has returned to the electronic device.

17. A portable electronic device, comprising:
an electric field sensor that generates signals indicative of changes in static electric field surrounding the electronic device;
a radio circuit over which communications for calls are carried out; and
a control circuit configured to detect an incoming call and silence or reduce volume of a ringer used to announce the call when the signals from the electric field sensor indicate movement of a user's hand near the electronic device.

18. A portable electronic device, comprising:
an electric field sensor that generates signals indicative of changes in static electric field surrounding the electronic device;
a radio circuit over which communications for calls are carried out;
a display with touch input functionality; and
a control circuit configured to detect establishment of a call and deactivate the display and touch input functionality when the signals from the electric field sensor indicate movement of the electronic device toward a user's head.

19. The portable electronic device of claim 18, wherein the control circuit is further configured to reactivate the display and touch input functionality when the signals from the electric field sensor indicate movement of the electronic device away from the user's head.
